(19) United States
(12) Patent Application Publication
(10) Pub. No.: US 2023/0254558 A1
(43) Pub. Date: Aug. 10, 2023

(54) POWER SAVING MECHANISMS FOR CAMERA DEVICES

(71) Applicant: META PLATFORMS TECHNOLOGIES, LLC, Menlo Park, CA (US)

(72) Inventors: Abhishek Dhanda, San Ramon, CA (US); Lidu Huang, Danville, CA (US); Yizhi Xiong, Foster City, CA (US); Honghong Peng, Mountain View, CA (US); Michael Andrew Brookmire, Half Moon Bay, CA (US)

(21) Appl. No.: 17/719,272

(22) Filed: Apr. 12, 2022

Related U.S. Application Data
(60) Provisional application No. 63/308,429, filed on Feb. 9, 2022.

(51) Int. Cl. H04N 5/225; G02B 27/64

(52) U.S. Cl. CPC H04N 5/2253; G02B 27/646; H04N 5/2254; H04N 5/23287

(57) ABSTRACT

Embodiments of the present disclosure relate to power saving mechanisms for a wearable camera device. The camera device comprises an image sensor and lens assembly in an optical series with the image sensor. At a first orientation of the camera device, an offset is between a center axis of the image sensor and an optical axis of the lens assembly. At a second orientation of the camera device, at least one of the image sensor and the lens assembly sag due to gravity such that the center axis and the optical axis substantially overlap while the camera device is in a neutral state. The lens assembly and the image sensor can further allow a dynamic amount of sag relative to each other.

### CROSS REFERENCE TO RELATED APPLICATIONS

This application claims a priority and benefit to U.S. Provisional Patent Application Ser. No. 63/308,429, filed Feb. 9, 2022, which is hereby incorporated by reference in its entirety.

### FIELD OF THE INVENTION

The present disclosure relates generally to camera devices, and specifically relates to power saving mechanisms for camera devices.

### BACKGROUND

In the most typical use case of a camera device, the camera device is facing forward with its lens in horizontal posture in optical series with an image sensor. Due to gravity, the lens as part a lens-shift design or the image sensor as part of a sensor-shift design would sag, and, therefore, the lens would not be in correct position relative to the image sensor. Additional power needs to be consumed to bring the lens or the image sensor in correct position relative to each other, which increases an overall power consumption of the camera device.

Optical image stabilization applied at the camera device requires tradeoff between power consumption and performance of the camera device. More camera stroke results in better performance for the camera device. However, power usage increases especially when compensating gravity sag. Letting lens of the camera device fully sag can save power but may not leave sufficient camera stroke, which negatively affects performance of the camera device especially for longer exposures of the camera device.

### SUMMARY

Embodiments of the present disclosure relate to a power saving mechanism for a camera device (e.g., wearable camera device) by having an image sensor of the camera device biased to one side relative to a lens assembly of the camera device. The lens assembly is in an optical series with the image sensor. At a first orientation of the camera device (e.g., upward or vertical posture of the camera device), there is an offset between a center axis of the image sensor and an optical axis of the lens assembly. At a second orientation of the camera device (e.g., forward or horizontal posture of the camera device), at least one of the image sensor and the lens assembly sag due to gravity such that the center axis and the optical axis substantially overlap while the camera device is in a neutral state.

Embodiments of the present disclosure further relate to a power saving mechanism for a camera device (e.g., wearable camera device) based on a dynamic sag compensation. The camera device includes an image sensor and a lens assembly in an optical series with the image sensor. The lens assembly and the image sensor are configured to allow a dynamic amount of sag relative to one another.

The camera device presented herein may be part of a wristband system, e.g., a smartwatch or some other electronic wearable device. Additionally or alternatively, the camera device may be part of a handheld electronic device (e.g., smartphone) or some other portable electronic device.

### BRIEF DESCRIPTION OF THE DRAWINGS

FIG. 1A is a top view of an example wristband system, in accordance with one or more embodiments.

FIG. 1B is a side view of the example wristband system of FIG. 1A.

FIG. 2A is a perspective view of another example wristband system, in accordance with one or more embodiments.

FIG. 2B is a perspective view of the example wristband system of FIG. 2A with a watch body released from a watch band, in accordance with one or more embodiments.

FIG. 3 is a cross section of an electronic wearable device, in accordance with one or more embodiments.

FIG. 4A is a cross section of a camera device in an upward (vertical) posture, in accordance with one or more embodiments.

FIG. 4B is a cross section of a camera device in a forward (horizontal) posture, in accordance with one or more embodiments.

FIG. 5 is a block diagram of an optical image stabilization applied at a camera device, in accordance with one or more embodiments.

FIG. 6A illustrates an example of a dynamic sag compensation for a shorter exposure and/or smaller motion of a camera device, in accordance with one or more embodiments.

FIG. 6B illustrates an example of a dynamic sag compensation for a longer exposure and/or larger motion of a camera device, in accordance with one or more embodiments.

FIG. 7 is a flowchart illustrating a process of dynamic sag compensation at a camera device, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Embodiments of the present disclosure relate to a camera device (e.g., wearable camera device) with an optical image stabilization (OIS) assembly and an autofocus assembly. While the camera device is oriented vertically (i.e., an optical axis is perpendicular to the ground), a lens assembly of the camera device is in an offset position relative to an image sensor of the camera device. While the camera device is tilted sideways (i.e., the optical axis is parallel to the ground), the lens assembly and/or the OIS assembly sag (e.g., due to gravity) such that the lens assembly is correctly positioned relative to the image sensor. In some embodiments, the camera device accounts for sag of the lens assembly relative to the image sensor such that an amount of allowed sag is dynamically controlled based in part on motion, or predicted motion of the camera device, an exposure time of the camera device, or some combination thereof.

The camera device may be incorporated into a small form factor electronic device, such as an electronic wearable device. Examples of electronic wearable devices include a smartwatch or a head-mount display (HMD). The electronic device can include other components (e.g., haptic devices, speakers, etc.). And, the small form factor of the electronic device provides limited space between the other components and the camera device. In some embodiments, the electronic device may have limited power supply (e.g., due to being dependent on a re-chargeable battery).

In some embodiments, the electronic wearable device may operate in an artificial reality environment (e.g., a virtual reality environment). The camera device of the electronic wearable device may be used to enhance an artificial reality application running on an artificial reality system (e.g., running on an HMD device worn by the user). The camera device may be disposed on multiple surfaces of the electronic wearable device such that data from a local area, e.g., surrounding a wrist of the user, may be captured in multiple directions. For example, one or more images may be captured describing the local area and the images may be sent and processed by the UND device prior to be presented to the user.

Embodiments of the present disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including an electronic wearable device (e.g., headset) connected to a host computer system, a standalone electronic wearable device (e.g., headset, smartwatch, bracelet, etc.), a mobile device or computing system, or any other hardware platform capable of providing artificial reality content to one or more viewers.

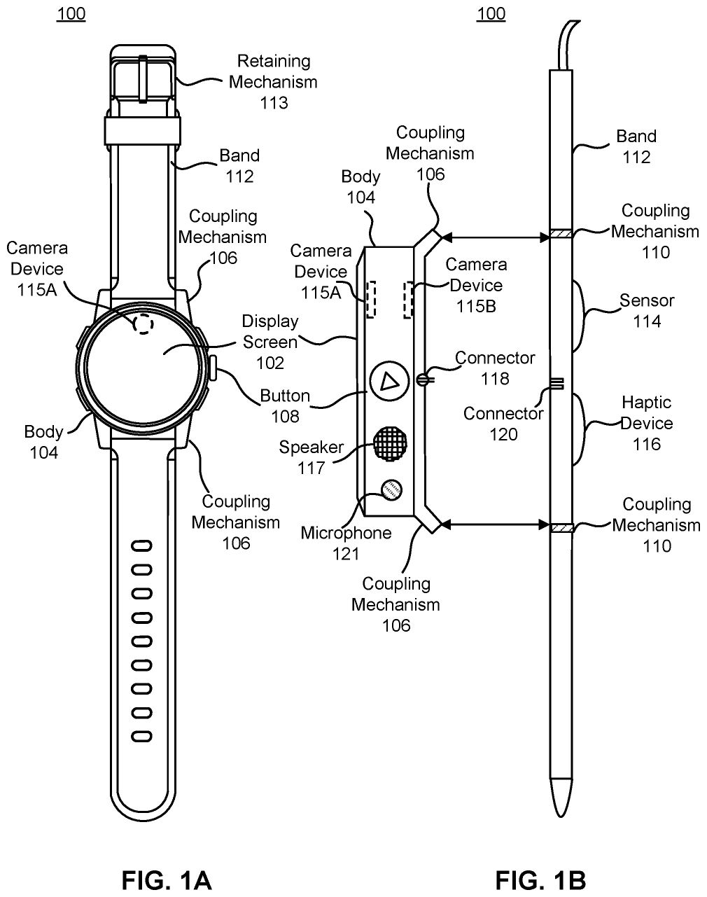

FIG. 1A is a top view of an example wristband system 100, in accordance with one or more embodiments. FIG. 1B is a side view of the example wristband system 100 of FIG. 1A. The wristband system 100 is an electronic wearable device and may be worn on a wrist or an arm of a user. In some embodiments, the wristband system 100 is a smartwatch. Media content may be presented to the user wearing the wristband system 100 using a display screen 102 and/or one or more speakers 117. However, the wristband system 100 may also be used such that media content is presented to a user in a different manner (e.g., via touch utilizing a haptic device 116). Examples of media content presented by the wristband system 100 include one or more images, video, audio, or some combination thereof. The wristband system 100 may operate in an artificial reality environment (e.g., a virtual reality environment, an augmented reality environment, a mixed reality environment, or some combination thereof).

In some examples, the wristband system 100 may include multiple electronic devices (not shown) including, without limitation, a smartphone, a server, a head-mounted display (HMD), a laptop computer, a desktop computer, a gaming system, Internet of things devices, etc. Such electronic devices may communicate with the wristband system 100 (e.g., via a personal area network). The wristband system 100 may have sufficient processing capabilities (e.g., CPU, memory, bandwidth, battery power, etc.) to offload computing tasks from each of the multiple electronic devices to the wristband system 100. Additionally, or alternatively, each of the multiple electronic devices may have sufficient processing capabilities (e.g., CPU, memory, bandwidth, battery power, etc.) to offload computing tasks from the wristband system 100 to the electronic device(s).

The wristband system 100 includes a watch body 104 coupled to a watch band 112 via one or more coupling mechanisms 106, 110. The watch body 104 may include, among other components, one or more coupling mechanisms 106, one or more camera devices 115 (e.g., camera device 115A and 115B), the display screen 102, a button 108, a connector 118, a speaker 117, and a microphone 121. The watch band 112 may include, among other components, one or more coupling mechanisms 110, a retaining mechanism 113, one or more sensors 114, the haptic device 116, and a connector 120. While FIGS. 1A and 1B illustrate the components of the wristband system 100 in example locations on the wristband system 100, the components may be located elsewhere on the wristband system 100, on a peripheral electronic device paired with the wristband system 100, or some combination thereof. Similarly, there may be more or fewer components on the wristband system 100 than what is shown in FIGS. 1A and 1B. For example, in some embodiments, the watch body 104 may include a port for connecting the wristband system 100 to a peripheral electronic device and/or to a power source. The port may enable charging of a battery of the wristband system 100 and/or communication between the wristband system 100 and a peripheral device. In another example, the watch body 104 may include an inertial measurement unit (IU) that measures a change in position, an orientation, and/or an acceleration of the wristband system 100. The IMU may include one or more sensors, such as one or more accelerometers, one or more gyroscopes, one or more magnetometers, another suitable type of sensor that detects motion, a type of sensor used for error correction of the IMU, or some combination thereof.

The watch body 104 and the watch band 112 may have any size and/or shape that is configured to allow a user to wear the wristband system 100 on a body part (e.g., a wrist). The wristband system 100 may include the retaining mechanism 113 (e.g., a buckle) for securing the watch band 112 to the wrist of the user. The coupling mechanism 106 of the watch body 104 and the coupling mechanism 110 of the watch band 112 may attach the watch body 104 to the watch band 112. For example, the coupling mechanism 106 may couple with the coupling mechanism 110 by sticking to, attaching to, fastening to, affixing to, some other suitable means for coupling to, or some combination thereof.

The wristband system 100 may perform various functions associated with the user. The functions may be executed independently in the watch body 104, independently in the watch band 112, and/or in communication between the watch body 104 and the watch band 112. In some embodiments, a user may select a function by interacting with the button 108 (e.g., by pushing, turning, etc.). In some embodiments, a user may select a function by interacting with the display screen 102. For example, the display screen 102 is a touchscreen and the user may select a particular function by touching the display screen 102. The functions executed by the wristband system 100 may include, without limitation, displaying visual content to the user (e.g., displaying visual content on the display screen 102), presenting audio content to the user (e.g., presenting audio content via the speaker 117), sensing user input (e.g., sensing a touch of button 108, sensing biometric data with the one or more sensors 114, sensing neuromuscular signals with the one or more sensors 114, etc.), capturing audio content (e.g., capturing audio with microphone 121), capturing data describing a local area (e.g., with a front-facing camera device 115A and/or a rear-facing camera device 115B), communicating wirelessly (e.g., via cellular, near field, Wi-Fi, personal area network, etc.), communicating via wire (e.g., via the port), determining location (e.g., sensing position data with a sensor 114), determining a change in position (e.g., sensing change(s) in position with an IMU), determining an orientation and/or acceleration (e.g., sensing orientation and/or acceleration data with an IMU), providing haptic feedback (e.g., with the haptic device 116), etc.

The display screen 102 may display visual content to the user. The displayed visual content may be oriented to the eye gaze of the user such that the content is easily viewed by the user. Traditional displays on wristband systems may orient the visual content in a static manner such that when a user moves or rotates the wristband system, the content may remain in the same position relative to the wristband system causing difficulty for the user to view the content. The displayed visual content may be oriented (e.g., rotated, flipped, stretched, etc.) such that the displayed content remains in substantially the same orientation relative to the eye gaze of the user (e.g., the direction in which the user is looking). The displayed visual content may also be modified based on the eye gaze of the user. For example, in order to reduce the power consumption of the wristband system 100, the display screen 102 may dim the brightness of the displayed visual content, pause the displaying of visual content, or power down the display screen 102 when it is determined that the user is not looking at the display screen 102. In some examples, one or more sensors 114 of the wristband system 100 may determine an orientation of the display screen 102 relative to an eye gaze direction of the user.

The position, orientation, and/or motion of eyes of the user may be measured in a variety of ways, including through the use of optical-based eye-tracking techniques, infrared-based eye-tracking techniques, etc. For example, the front-facing camera device 115A and/or rear-facing camera device 115B may capture data (e.g., visible light, infrared light, etc.) of the local area surrounding the wristband system 100 including the eyes of the user. The captured data may be processed by a controller (not shown) internal to the wristband system 100, a controller external to and in communication with the wristband system 100 (e.g., a controller of an HMD), or a combination thereof to determine the eye gaze direction of the user. The display screen 102 may receive the determined eye gaze direction and orient the displayed content based on the eye gaze direction of the user.

In some embodiments, the watch body 104 may be communicatively coupled to an HMD. The front-facing camera device 115A and/or the rear-facing camera device 115B may capture data describing the local area, such as one or more wide-angle images of the local area surrounding the front-facing camera device 115A and/or the rear-facing camera device 115B. The wide-angle images may include hemispherical images (e.g., at least hemispherical, substantially spherical, etc.), 180-degree images, 360-degree area images, panoramic images, ultra-wide area images, or a combination thereof. In some examples, the front-facing camera device 115A and/or the rear-facing camera device 115B may be configured to capture images having a range between 45 degrees and 360 degrees. The captured data may be communicated to the HMD and displayed to the user on a display screen of the HMD worn by the user. In some examples, the captured data may be displayed to the user in conjunction with an artificial reality application. In some embodiments, images captured by the front-facing camera device 115A and/or the rear-facing camera device 115B may be processed before being displayed on the HMD. For example, certain features and/or objects (e.g., people, faces, devices, backgrounds, etc.) of the captured data may be subtracted, added, and/or enhanced before displaying on the HMD.

Components of the front-facing camera device 115A and the rear-facing camera device 115B may be capable of taking pictures capturing data describing the local area. A lens of the front-facing camera device 115A and/or a lens of the rear-facing camera device 115B can be automatically positioned at their target positions. A target position in a forward (or horizontal) posture of the front-facing camera device 115A may correspond to a position at which the lens of the front-facing camera device 115A is focused at its preferred focal distance (e.g., distance in the order of several decimeters). A target position in a forward (or horizontal) posture of the rear-facing camera device 115B may correspond to a position at which the lens of the rear-facing camera device 115B is focused at its hyperfocal distance in the local area (e.g., a distance of approximately 1.7 meter).

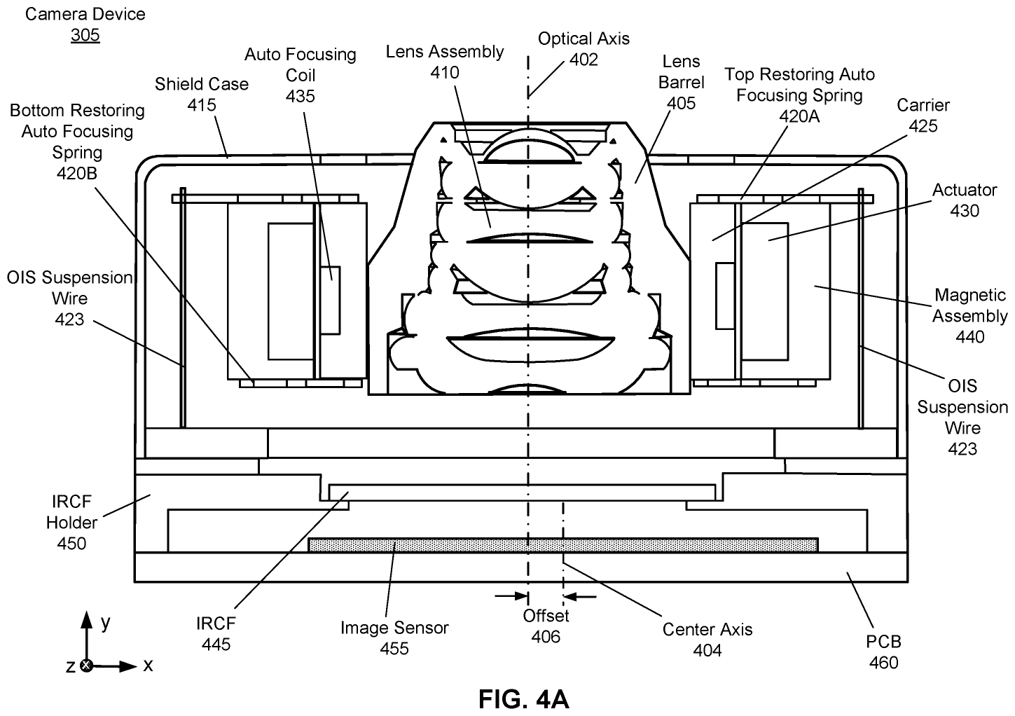

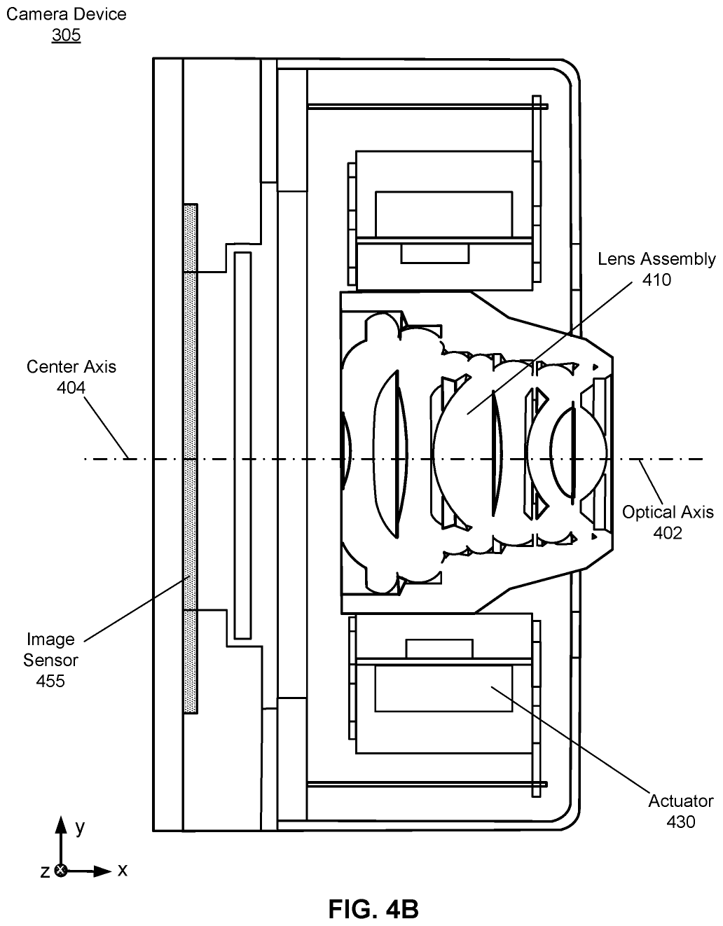

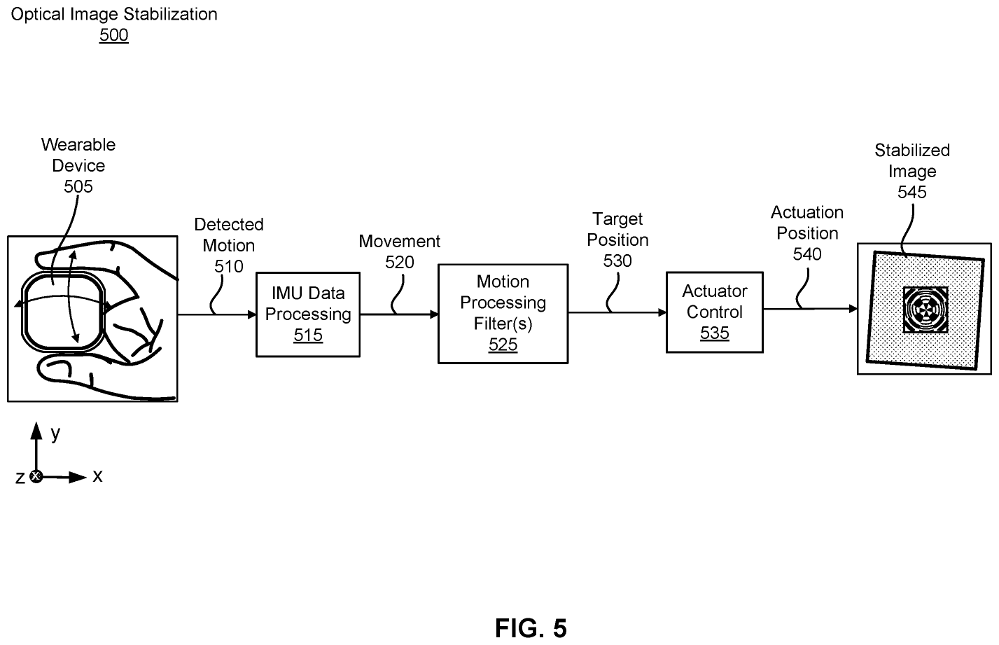

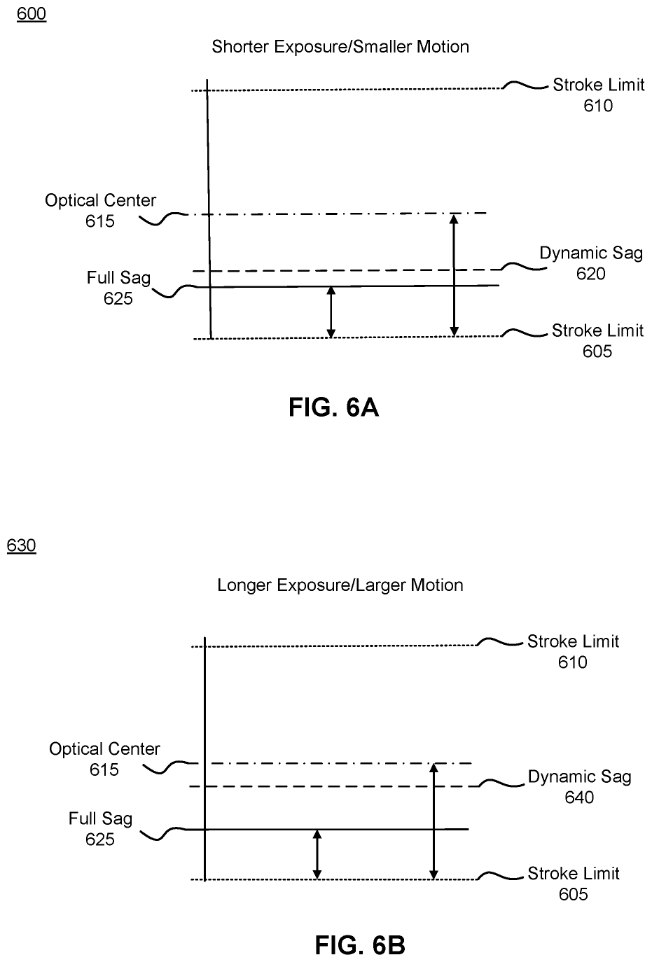

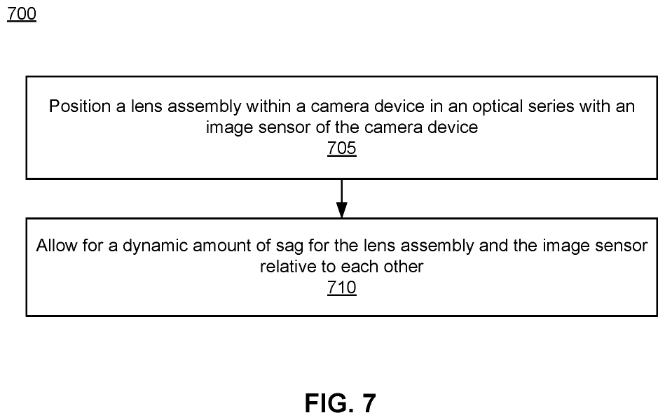

While the front-facing camera device 115A and/or the rear-facing camera device 115B are oriented vertically (i.e., an optical axis is perpendicular to the ground), their lens assembly may be in an offset position relative to an image sensor of the respective front-facing camera device 115A and the rear-facing camera device 115B. Because of this offset position, while the front-facing camera device 115A and/or the rear-facing camera device 115B is tilted sideways (i.e., the optical axis is parallel to the ground), their lens assembly and/or OIS assembly sag (e.g., due to gravity) such that the lens assembly is correctly positioned relative to the image sensor. Details about this mechanism are provided below in relation to FIGS. 4A-4B. In some embodiments, the front-facing camera device 115A and/or the rear-facing camera device 115B account for sag of their lens assembly relative to the image sensor such that an amount of allowed sag is dynamically controlled based in part on motion of the respective the front-facing camera device 115A and the rear-facing camera device 115B, an exposure time of the respective the front-facing camera device 115A and the rear-facing camera device 115B, or some combination thereof. Details about this mechanism are provided below in relation to FIG. 5. FIG. 6A-6B and FIG. 7.

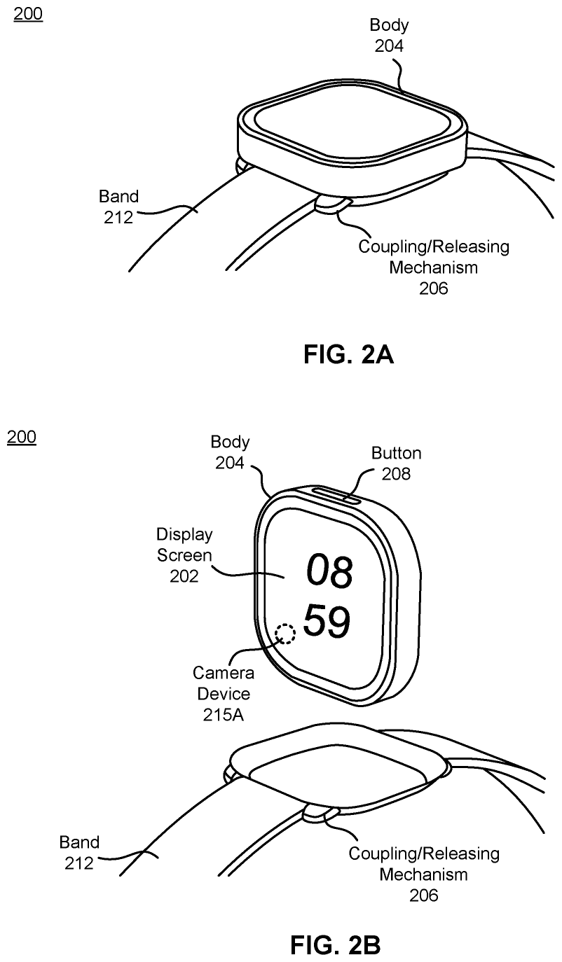

FIG. 2A is a perspective view of another example wristband system 200, in accordance with one or more embodiments. The wristband system 200 includes many of the same components described above with reference to FIGS. 1A and 1B, but a design or layout of the components may be modified to integrate with a different form factor. For example, the wristband system 200 includes a watch body 204 and a watch band 212 of different shapes and with different layouts of components compared to the watch body 104 and the watch band 112 of the wristband system 100. FIG. 2A further illustrates a coupling/releasing mechanism 206 for coupling/releasing the watch body 204 to/from the watch band 212.

FIG. 2B is a perspective view of the example wristband system 200 with the watch body 204 released from the watch band 212, in accordance with one or more embodiments. FIG. 2B further illustrates a camera device 215A, a display screen 202, and a button 208. In some embodiments, another camera device may be located on an underside of the watch body 204 and is not shown in FIG. 2B. In some embodiments (not shown in FIGS. 2A-2B), one or more sensors, a speaker, a microphone, a haptic device, a retaining mechanism, etc. may be included on the watch body 204 or the watch band 212. As the wristband system 100 and the wristband system 200 are of a small form factor to be easily and comfortably worn on a wrist of a user, the corresponding camera devices 115, 215 and various other components of the wristband system 100 and the wristband system 200 described above are designed to be of an even smaller form factor and are positioned close to each other.

In some embodiments, components of the camera device 215 are positioned within the camera device 215 such that when the camera device 215 is at the upward (vertical) posture, there is an offset between an optical axis of a lens and a center axis of a sensor of the camera device 215. And when the camera device 215 is at the forward (horizontal) posture to take a picture capturing data describing a local area, the lens and the sensor sag due to gravity such that the optical axis of the lens and the center axes of the sensor substantially overlap, while the camera device 215 is in a neutral state. In this manner, power is saved that would be otherwise consumed to bring the lens and sensor in correct positions relative to one another. Details about this power saving mechanism are provided below in relation to FIGS. 4A-4B. The substantial overlapping of the optical axis and the center axes can be defined as the optical axis and the center axes being within a predetermined threshold from one another. The neutral state of the camera device 215 can be defined as a state during which neither activation nor stabilization is applied at the camera device 215. In some other embodiments, the lens and the sensor of the camera device 215 allow a dynamic amount of sag relative to one another, e.g., based on at least one of a motion (or predicted motion) of the camera device 215 and an exposure time of the camera device 215. In this manner, power is saved that would be otherwise consumed as part of image stabilization. Details about this power saving mechanism are provided below in relation to FIG. 5, FIGS. 6A-6B and FIG. 7.

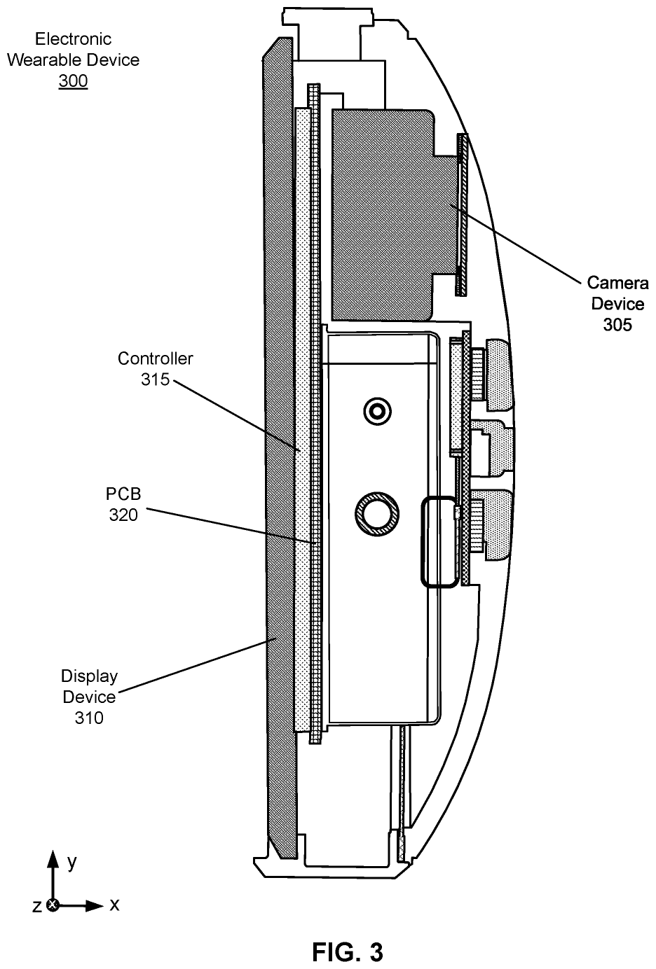

FIG. 3 is a cross section of an electronic wearable device 300, in accordance with one or more embodiments. The electronic wearable device 300 may be worn on a wrist or an arm of a user. In some embodiments, the electronic wearable device 300 is a smartwatch. The electronic wearable device 300 may be an embodiment of the wristband system 100 or the wristband system 200. The electronic wearable device 300 is shown in FIG. 3 in the forward (horizontal) posture. The electronic wearable device 300 includes a camera device 305, a display device 310, a controller 315, and a printed circuit board (PCB) 320. There may be more or fewer components of the electronic wearable device 300 than what is shown in FIG. 3.

The camera device 305 may capture data (e.g., one or more images) of a local area surrounding the electronic wearable device 300. The camera device 305 may be an embodiment of the camera devices 115, 215. Details about a structure and operation of the camera device 305 are provided below in relation to FIGS. 4A and 4B.

The display device 310 may display visual content to the user on a display screen of the display device 310. Additionally, the display device 310 may present audio content to the user, sense user input, capture audio content, capturing data describing a local area (e.g., with the camera device 305), communicate wirelessly, communicate via wire, determine location, determine a change in position, determining an orientation and/or acceleration, providing haptic feedback, and/or provide some other function. The display screen of the display device 310 may be an embodiment of the display screen 102 or the display screen 202.

The controller 315 may control operations of the camera device 305, the display device 310 and/or some other component(s) of the electronic wearable device 300. The controller 315 may control OIS, autofocusing, actuation, some other operation applied at the camera device 305, or some combination thereof. The controller 315 may also process data captured by the camera device 305. Furthermore, the controller 315 may control any aforementioned functions of the display device 310. In some embodiments, the controller 315 is part of the camera device 305

The PCB 320 is a stationary component of the electronic wearable device 300 and provides mechanical support (e.g., by acting as a base) for the electronic wearable device 300. The PCB 320 may provide electrical connections for the camera device 305, the display device 310 and the controller 315. The PCB 320 may also electrically connect the controller 315 to the camera device 305 and the display device 310.

FIG. 4A is a cross section of the camera device 305 in an upward (vertical) posture, in accordance with one or more embodiments. The camera device 305 includes a lens barrel 405, a lens assembly 410, a shield case 415, one or more top restoring auto focusing springs 420A, one or more bottom restoring auto focusing springs 420B, one or more OIS suspension wires 423, a carrier 425, one or more actuators 430, one or more auto focusing coils 435, a magnetic assembly 440, an infrared cut-off filter (IRCF) 445, an IRCF holder 450, an image sensor 455, and a PCB 460. The one or more top restoring auto focusing springs 420A together with the one or more bottom restoring auto focusing springs 420B are collectively referred to herein as “one or more restoring auto focusing springs 420.” In alternative configurations, different and/or additional components may be included in the camera device 305. For example, in some embodiments, the camera device 305 may include a controller (not shown in FIG. 4A). In alternative embodiments (as shown in FIG. 3), the controller 315 is a component of the electronic wearable device 300 positioned outside the camera device 305.

The camera device 305 is configured to have both a focusing assembly and a stabilization assembly. The focusing assembly is configured to cause a translation of the lens barrel 405 in a direction parallel to an optical axis 402 of the lens assembly 410. The focusing assembly provides an auto focus functionality for the camera device 305. The focusing assembly includes the one or more restoring auto focusing springs 420, the one or more OIS suspension wires 423, and a plurality of magnets included in the magnetic assembly 440. The stabilization assembly is configured to cause a translation of the lens barrel 405 (and, in some embodiments, the magnetic assembly 440 and the lens barrel 405) in one or more directions perpendicular to the optical axis 402. The stabilization assembly provides an OIS functionality for the camera device 305 by stabilizing an image projected through the lens barrel 405 to the image sensor 455. The stabilization assembly includes the lens barrel 405, the shield case 415, and the magnetic assembly 440.

The lens barrel 405 is a mechanical structure or housing for carrying one or more lenses of the lens assembly 410. The lens barrel 405 is a hollow structure with an opening on opposite ends of the lens barrel 405. The openings may provide a path for light (e.g., visible light, infrared light, etc.) to transmit between a local area and the image sensor 455. Inside the lens barrel 405, one or more lenses of the lens assembly 410 are positioned between the two openings. The lens barrel 405 may be manufactured from a wide variety of materials ranging from plastic to metals. In some embodiments, one or more exterior surfaces of the lens barrel 305 are coated with a polymer (e.g., a sub-micron thick polymer). The lens barrel 405 may be rotationally symmetric about the optical axis 402 of the one or more lenses of the lens assembly 310.

The lens barrel 405 may be coupled to the magnetic assembly 440 by the one or more restoring auto focusing springs 420. For example, the one or more restoring auto focusing springs 420 are coupled to the lens barrel 405 and the magnetic assembly 440. In some embodiments, the magnetic assembly 440 is coupled to the shield case 415. In another example (not illustrated), the one or more restoring auto focusing springs 420 are coupled to the shield case 415 directly and the lens barrel 405. The one or more restoring auto focusing springs 420 are configured to control a positioning of the lens barrel 405 along the optical axis 402. For example, the plurality of restoring auto focusing springs 420 may control the positioning of the lens barrel 405 such that when current is not supplied to the one or more auto focusing coils 435 the lens barrel 405 is in a neutral position. In some embodiments, the one or more restoring auto focusing springs 420 may be shape-memory alloy (SMA) wires. The neutral position of the lens barrel 405 is a positioning of the lens barrel 405 when the camera device 305 is not undergoing focusing (via the focusing assembly) nor stabilizing (via the stabilization assembly). The one or more restoring auto focusing springs 420 can ensure the lens barrel 405 does not fall out or come into contact with the image sensor 455. In some embodiments, the one or more restoring auto focusing springs 420 are conductors and may be coupled to the one or more auto focusing coils 435. In these embodiments, the plurality of restoring auto focusing springs 420 may be used to provide current to the one or more auto focusing coils 435. The one or more restoring auto focusing springs 420 may be coupled to the one or more OIS suspension wires 423 that provide current to the one or more restoring auto focusing springs 420 so that the one or more restoring auto focusing springs 420 can facilitate auto focusing of the lens assembly 410. The one or more OIS suspension wires 423 may be positioned symmetrically about the optical axis 402.

The shield case 415 may enclose some of the components of the camera device 305 as illustrated in FIG. 4A. In other embodiments (not shown), the shield case 415 may encloses all of the components of the camera device 305. The shield case 415 may partially enclose the lens barrel 405. The shield case 415 provides a space in which the lens barrel 405 can translate along the optical axis 402 and/or translate in a direction perpendicular to the optical axis 402. In some embodiments, the shield case 415 provides a space in which the lens barrel 405 rotates relative to one or more axes that are perpendicular to the optical axis 402. In some embodiments, the shield case 415 may be rectangular-shaped as illustrated. In alternative embodiments, the shield case 415 may be circular, square, hexagonal, or any other shape. In embodiments where the camera device 305 is part of another electronic device (e.g., a smartwatch), the shield case 415 may couple to (e.g., be mounted on, affixed to, attached to, etc.) another component of the electronic device, such as a frame of the electronic device. For example, the shield case 415 may be mounted on a watch body (e.g., the watch body 104) of the smartwatch. The shield case 415 may be manufactured from a wide variety of materials ranging from plastic to metals. In some examples, the shield case 415 is manufactured from a same material as the material of the electronic device the shield case 415 is coupled to such that the shield case 415 is not distinguishable from the rest of the electronic device. In some embodiments, the shield case 415 is manufactured from a material that provides a magnetic shield to surrounding components of the electronic device. In these embodiments, the shield case 415 may be a shield can. In some embodiments, one or more interior surfaces of the shield case 415 are coated with a polymer similar to the lens barrel 405 described above.

The carrier 425 is directly coupled to the lens barrel 405. For example, the carrier 425 comprises a first side in direct contact with a surface of the lens barrel 405 and a second side opposite the first side. In some embodiments, the carrier 425 is coupled to the lens barrel 405 by an adhesive. The one or more auto focusing coils 435 may be affixed to the second side of the carrier 425. The carrier 425 has a curvature that conforms to the curvature of the lens barrel 405. In some embodiments, more than one carrier 425 may be directly coupled to the lens barrel 405. In these embodiments, the number of carriers 425 may match a number of auto focusing coils 435 and the carriers 425 may be positioned at unique locations around the lens barrel 405 such that a carrier 425 is positioned between a corresponding auto focusing coil 435 and the lens barrel 405. In some embodiments, the restoring auto focusing springs 420 may be coupled to the carrier 425.

The one or more auto focusing coils 435 are configured to conduct electricity by being supplied with a current. The one or more auto focusing coils 435 may be positioned symmetrically about the optical axis 402. For example, the one or more auto focusing coils 435 may consist of two individual coils positioned symmetrically about the optical axis 402, as illustrated in FIG. 4A. The one or more auto focusing coils 435 are coupled to the one or more actuators 430 and provide the current to the one or more actuators 430.

The one or more actuators 430 are configured to provide auto focusing to the one or more lenses of the lens assembly 410. The one or more actuators 430 consume an auto focusing actuation power while providing auto focusing to the one or more lenses of the lens assembly 410. To reduce (and in some cases minimize) a level of the auto focusing actuation power consumption (e.g., to achieve the zero level auto focusing actuation power), relative positions of the lens assembly 410, the carrier 425 and the one or more actuators 430 along the optical axis 402 may be controlled during assembling of the camera device 305.

The magnetic assembly 440 includes a magnet holder for holding a plurality of magnets. The magnet holder may provide a rigid structure to support the plurality of magnets. In some embodiments, the magnet holder may enclose all sides of the magnets. In other embodiments, the magnet holder may enclose all sides of the magnets except for a side facing the one or more auto focusing coils 435. In some embodiments, one or more exterior surfaces of the magnetic assembly 440 are coated with a polymer similar to the lens barrel 305 described above.

The plurality of magnets of the magnetic assembly 440 generate magnetic fields that can be used for translating the lens barrel 405 along the optical axis 402 (e.g., focusing the camera device 305) and/or perpendicular to the optical axis 402 (e.g., providing OIS for the camera device 305). The magnetic fields used for focusing the camera device 305 can be applied in the forward (horizontal) posture of the camera device 305, e.g., to focus the lens assembly 410 at the hyperfocal distance.

Each magnet of the plurality of magnets may be a different size or the same size. In some embodiments, each magnet is curved about the optical axis 402 conforming to the curvature of the one or more auto focusing coils 435 and the lens barrel 405. In some embodiments, each magnet is straight. For example, at least two opposing sides of each magnet are parallel to a plane that is parallel to the optical axis 402. Each magnet of the plurality of magnets may include rectangular cross sections with one axis of a cross section being parallel to the optical axis 402 and another axis of the cross section being perpendicular to the optical axis 402. In some embodiments, each magnet may include other types of cross-sectional shapes such as square or any other shape that includes at least one straight-edged side that faces the one or more auto focusing coils 435. Each magnet is a permanent magnet that is radially magnetized with respect to the optical axis 402. The magnets may be positioned symmetrically about the optical axis 402.

The image sensor 455 captures data (e.g., one or more images) describing a local area. The image sensor 455 may include one or more individual sensors, e.g., a photodetector, a CMOS sensor, a CCD sensor, some other device for detecting light, or some combination thereof. The individual sensors may be in an array. For a camera device 305 integrated into an electronic device, the local area is an area surrounding the electronic device. The image sensor 455 captures light from the local area. The image sensor 455 may capture visible light and/or infrared light from the local area surrounding the electronic device. The visible and/or infrared light is focused from the local area to the image sensor 455 via the lens barrel 405. The image sensor 455 may include various filters, such as the IRCF 445. The IRCF 445 is a filter configured to block the infrared light from the local area and propagate the visible light to the image sensor 455. The IRCF 445 may be placed within the IRCF holder 450.

At the upward (vertical) posture of the camera device 305 shown in FIG. 4A, the camera device 305 is configured such that there is an offset 406 between a center axis 404 of the image sensor 455 and the optical axis 402. In other words, the image sensor 455 is biased to one side relative to the lens assembly 410. The offset 406 may correspond to a nominal sag of, e.g., between approximately 30 μm and 80 μm. The amount of offset 406 may be a function of a design of the one or more restoring auto focusing springs 420, a sensitivity (e.g., stiffness) of the one or more restoring auto focusing springs 420, a weight of the actuator 430, a weight of the one or more restoring auto focusing springs 420, some other variable, or some combination thereof. The upward (vertical) posture of the camera device 305 corresponds to a posture of the camera device 305 where the optical axis 402 and the center axis are substantially parallel to gravity (e.g., parallel to y axis in FIG. 4A). On the other hand, the forward (horizontal) posture of the camera device 305 (shown in FIG. 4B) corresponds to a posture of the camera device 305 with the optical axis 402 substantially orthogonal to gravity (e.g., parallel to x axis in FIG. 4B).

The PCB 460 is positioned below the image sensor 455 along the optical axis 402. The PCB 460 is a stationary component of the camera device 305 and provides mechanical support (e.g., by acting as a base) for the camera device 305. The PCB 460 may provide electrical connections for one or more components of the camera device 305. In some embodiments, a controller may be located on the PCB 460 and the PCB 460 electrically connects the controller to various components (e.g., the one or more auto focusing coils 435) of the camera device 305. In other embodiments (as shown in FIG. 3), the controller 320 is located externally to the camera device 305.

FIG. 4B is a cross section of the camera device 305 in a forward (horizontal) posture, in accordance with one or more embodiments. The cross section of the camera device 305 in FIG. 4B corresponds to the most typical use case of the camera device 305 at which the one or more lenses of the lens assembly 410 are also in the horizontal posture. At the forward posture of the camera device 305, at least one of the image sensor 455 and the lens assembly 410 sag due to gravity such that the center axis 404 and the optical axis 402 substantially overlap while the camera device 305 is in the neutral state. The camera device 305 may be in the neutral state when neither activation not stabilization is applied to the lens assembly 410. Furthermore, at the forward posture of the camera device 305 and the neutral state, the lens assembly 410 may be at a hyperfocal position relative to the image sensor 455. The hyperfocal position of the lens assembly 410 corresponds to a position of the lens assembly 410 within the camera device 305 at which the lens assembly 410 is focused at a hyperfocal distance within a local area (e.g., 1.7 meter) when the camera device 305 is at the forward posture.

While the camera device 305 is at the forward posture (as shown in FIG. 4B), the optical axis 402 and the center axis 404 are both orthogonal to gravity. In one embodiment, while the camera device 305 is at the forward posture, the image sensor 455 is fixed within the camera device 305 and the lens assembly 410 sags due to gravity. In another embodiment, while the camera device 305 is at the forward posture, the lens assembly 410 is fixed within the camera device 305 and the image sensor 455 sags due to gravity. Due to sagging of the lens assembly 410 and/or the image sensor 455, the optical axis 402 may be positioned relative to the center axis 404 within a threshold offset (e.g., 50 μm or less) smaller than the offset 406, while the camera device 305 is at the forward posture. In one or more embodiments, the threshold offset is, e.g., 50 μm or less. In one or more other embodiments, the threshold offset is, e.g., between approximately 10 μm and 80 μm. Thus, without any additional power consumption, the image sensor 455 and the lens assembly 410 are at correct positions to one another thanks to sagging of the image sensor 455 and/or the lens assembly 410 when the camera device 305 is at the forward posture. The amount of offset 406 at the upward posture of the camera device 305 and the amount of threshold offset between the optical axis 402 and the center axis 404 at the forward posture of the camera device 305 may be limited to ensure the image sensor 455 remains inside an image circle of the lens assembly 410 at the forward posture of the camera device 305 even with sagging of stabilization assembly.

Embodiments of the present disclosure further relate to a power saving approach for the camera device 305 based on a dynamic sag compensation. The lens assembly 410 and the image sensor 455 may allow a dynamic amount of sag relative to one another. The dynamic amount of sag may be based on information from, e.g., an OIS assembly of the camera device 305. The dynamic amount of sag may be a function of at least one of an exposure duration of the camera device 305 and a change in position of the camera device 305 in one or more spatial directions. In one embodiment, the dynamic amount of sag decreases when the exposure duration of the camera device 305 is longer than a threshold duration. In another embodiment, the dynamic amount of sag decreases when the change in position of the camera device 305 is greater than a threshold change along at least one spatial direction. In yet another embodiment, the dynamic amount of sag increases when the exposure duration of the camera device 305 is shorter than a threshold duration. In yet another embodiment, the dynamic amount of sag increases when the change in position of the camera device is smaller than a threshold change along at least one spatial direction.

FIG. 5 is an example block diagram 500 of the OIS functionality applied at the camera device 305, in accordance with one or more embodiments. As shown in FIG. 5, a wearable device 505 (e.g., smartwatch) may be moved by a user along x axis and/or y axis (e.g., along one or two spatial dimensions) while having a specific exposure. In some cases, z axis is substantially orthogonal to the gravity vector. The wearable device 505 may be an embodiment of the electronic wearable device 300, i.e., the wearable device 505 may include the camera device 305. To reduce a level of blur in an image taken by the camera device 305 of the wearable device 505, the OIS as shown in FIG. 5 may be applied by, e.g., the stabilization assembly of the camera device 305 and the controller 315. The OIS shown in FIG. 5 may be combined with embodiments described in relation to FIGS. 4A-4B, or may be independent from these embodiments.

An IMU of the wearable device 505 may detect translation and rotational motion 510 of the wearable device 505. The detected motion 510 may be utilized at the IMU data processing 515 to determine a movement 520 of the camera device 305 (e.g., an angular movement of the lens assembly 410 and/or the image sensor 455). The determined information about movement 520 may be then processed through one or more motion processing filters 525 (e.g., implemented at the controller 315) to determine a target (or predicted) position 530 along x axis and/or y axis for the lens assembly and/or the image sensor. An actuator control 535 (e.g., applied via the actuator 430 and/or the controller 315) may utilize information about the target position 530 to determine actuation position 540 associated with final position(s) of the lens assembly and/or the image sensor. The actuator control 535 may have a high bandwidth and a small phase delay (i.e., fast settling) to provide fast stabilization of motion for the wearable device 505. The actuator control 535 may also feature a proper handshake with an electronic image stabilization (EIS) of the wearable device 505. The final positions for the lens assembly and/or the image sensor (e.g., within the camera device 305) may result into taking a stabilized image 545.

It should be noted that there is a power vs. performance tradeoff for the stabilization assembly that provides the OIS functionality for the wearable device 505 (and the camera device 305). More stroke associated with the camera device 305 results in better performance. However, power usage of the camera device 305 increases especially when compensating gravity sag. Letting the lens assembly 410 fully sag saves power but might not leave sufficient stroke in one direction. This would have performance impact especially for a longer exposure (integration) of the camera device 305. The solution presented herein is to allow a dynamic sag at the camera device 305 as a function of integration time and/or movement of the camera device 305. If the OIS is required (e.g., with longer integration times or high motion environment), there is a higher probability of running out of stroke. In such case, a less amount of sag is allowed for lens assembly 410 and/or the image sensor 455. On the other hand, for shorter exposures and/or less movement of the camera device 305—more sag is allowed for the lens assembly 410 and/or the image sensor 455.

In some embodiments, the image sensor is fixed 455 and the stabilization assembly of the camera device 305 that provides the OIS functionality shown in FIG. 5 is allowed to move. While the camera device 305 is in forward (horizontal) posture, the stabilization assembly would sag due to gravity thereby reducing an amount of vertical stroke in the y direction as the stabilization assembly no longer would be centered unless power was expended. This would limit a range of vibration compensation in the y direction. Thus, for long exposures where there is likely to be a lot of vibration, the system reduces sag, and the power is spent to center the stabilization assembly to increase the range of potential vibration.

The OIS illustrated in FIG. 5 may fully compensate hand motion of the wearable device 505. A reference sagged position for the lens assembly and/or the image sensor may be decided by an operating point (i.e., power vs performance tradeoff) based on an integration time and/or IMU signal (e.g., detected motion). During the OIS 500, motion of the wearable device 505 may be integrated over frame exposure time and may be converted to a required actuator motion in x and y axes. A maximum amount of the actuator shift in x or y direction can be referred to herein as an “actuator stroke”. An amount of actuator stroke is limited, which further limits an amount of the device motion that can be stabilized. The OIS stroke requirement may be directly related to an exposure time (e.g., longer exposure requires larger motion in x and/or y direction), and an amount of device motion (e.g., larger motion and more aggressive shaking/motion of the wearable device 505 and its camera device would require larger OIS stroke for stabilization). At the same time, power consumption may be directly correlated to how far the actuator needs to be shifted with respect to a neutral or sagged position. These two effects may define power consumption, performance, and stroke tradeoffs at the camera device. The actuator can be allowed to sag if an amount of motion required for stabilization is small, thereby saving power consumption without impacting performance. Since the amount of motion is a direct function of exposure time and device motion, the OIS sag amount can be made function of those parameters and can be adjusted dynamically based on one or more signals from an auto-exposure (AE) unit and/or the IMU of the camera device (e.g., the camera device 305) integrated into the wearable device 505.

FIG. 6A illustrates an example 600 of a dynamic sag compensation for a shorter exposure and/or smaller motion of a camera device (e.g., the camera device 305), in accordance with one or more embodiments. A stroke of the camera device 305 may be limited by stroke limits 605 and 610 (i.e., stroke boundaries). An optical center 615 is a center between the stroke limits 605 and 610, and may correspond to the optical axis 402 of the lens assembly 402 or the center axis 404 of the image sensor 455. A level of dynamic sag 620 for the lens assembly 410 and/or the image sensor 455 is allowed between the optical center 615 and a full sag 625. FIG. 6B illustrates an example 630 of a dynamic sag compensation for a longer exposure and/or larger motion of a camera device (e.g., the camera device 305), in accordance with one or more embodiments. A level of dynamic sag 640 for the lens assembly 410 and/or the image sensor 455 is allowed between the optical center 615 and the full sag 625. Due to a shorter exposure and/or less movement of the camera device 305—more sag is allowed in FIG. 6A than in FIG. 6B, i.e., the level of dynamic sag 620 in FIG. 6A is higher relative to the level of dynamic sag 640 in FIG. 6B.

FIG. 7 is a flowchart illustrating a process 700 of dynamic sag compensation at a camera device, in accordance with one or more embodiments. Steps of the process 700 may be performed by one or more components of the camera device (e.g., the camera device 305). Embodiments may include different and/or additional steps of the process 700, or perform the steps of the process 700 in different orders.

At 705, the lens assembly is positioned within the camera device in an optical series with an image sensor of the camera device. At a first orientation of the camera device (e.g., at the upward posture of the camera device), there is an offset between a center axis of the image sensor and an optical axis of the lens assembly. At a second orientation of the camera device (e.g., at the forward posture of the camera device), at least one of the image sensor and the lens assembly sag due to gravity such that the center axis and the optical axis substantially overlap (e.g., the center axis and the optical axis are within a threshold offset to one another) while the camera device is in a neutral state. The image sensor may be fixed within the camera device, and the lens assembly may sag due to gravity while the camera device is at the second orientation. Alternatively, the lens assembly may be fixed within the camera device, and the image sensor may sag due to gravity while the camera device is at the second orientation.

At 710, a dynamic amount of sag is allowed for the lens assembly and the image sensor relative to each other. The dynamic amount of sag may be based on information from an OIS assembly of the camera device. The dynamic amount of sag may be a function of at least one of an exposure duration of the camera device and a change in position of the camera device in one or more spatial directions. The dynamic amount of sag may decrease when the exposure duration is longer than a threshold duration and/or the change in position is greater than a threshold change. The dynamic amount of sag may increase when the exposure duration is shorter than a threshold duration and/or the change in position is smaller than a threshold change.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A camera device comprising:
an image sensor; and
a lens assembly in an optical series with the image sensor, wherein
at a first orientation of the camera device, an offset is between a center axis of the image sensor and an optical axis of the lens assembly, and
at a second orientation of the camera device, at least one of the image sensor and the lens assembly sag due to gravity such that the center axis and the optical axis substantially overlap while the camera device is in a neutral state.

2. The camera device of claim 1, wherein:
the optical axis and the center axis are parallel to gravity, while the camera device is at the first orientation; and
the optical axis and the center axis are orthogonal to gravity, while the camera device is at the second orientation.

3. The camera device of claim 1, wherein the optical axis is positioned relative to the center axis within a threshold offset smaller than the offset, while the camera device is at the second orientation.

4. The camera device of claim 1, wherein the image sensor is fixed within the camera device, and the lens assembly sags due to gravity while the camera device is at the second orientation.

5. The camera device of claim 1, wherein the image sensor sags due to gravity while the camera device is at the second orientation.

6. The camera device of claim 1, wherein the lens assembly and the image sensor allow a dynamic amount of sag relative to each other.

7. The camera device of claim 6, wherein the dynamic amount of sag is based on information from an optical image stabilization (OIS) assembly of the camera device.

8. The camera device of claim 6, wherein the dynamic amount of sag is a function of at least one of an exposure duration of the camera device and a change in position of the camera device in one or more spatial directions.

9. The camera device of claim 8, wherein the dynamic amount of sag decreases when the exposure duration is longer than a threshold duration.

10. The camera device of claim 8, wherein the dynamic amount of sag decreases when the change in position is greater than a threshold change along one of the one or more spatial directions.

11. The camera device of claim 8, wherein the dynamic amount of sag increases when the exposure duration is shorter than a threshold duration.

12. The camera device of claim 8, wherein the dynamic amount of sag increases when the change in position is smaller than a threshold change along one of the one or more spatial directions.

13. The camera device of claim 1, wherein the camera device is in the neutral state when no activation is applied to the lens assembly.

14. The camera device of claim 1, wherein the camera device is part of a smartwatch.

15. A camera device comprising:
an image sensor; and
a lens assembly in an optical series with the image sensor, wherein
the lens assembly and the image sensor allow a dynamic amount of sag relative to each other.

16. The camera device of claim 15, wherein:
the camera device further incudes an optical image stabilization (OIS) assembly; and
the dynamic amount of sag is based on information from the OIS assembly.

17. The camera device of claim 15, wherein the dynamic amount of sag is a function of at least one of an exposure duration of the camera device and a change in position of the camera device in one or more spatial directions.

18. A wristband system comprising:
a camera device including an image sensor and a lens assembly in an optical series with the image sensor, wherein
at a first orientation of the camera device, an offset is between a center axis of the image sensor and an optical axis of the lens assembly, and
at a second orientation of the camera device, at least one of the image sensor and the lens assembly sag due to gravity such that the center axis and the optical axis substantially overlap while the camera device is in a neutral state.

19. The wristband system of claim 18, wherein the image sensor is fixed within the camera device, and the lens assembly sags due to gravity while the camera device is at the second orientation.

20. The wristband system of claim 18, wherein the lens assembly and the image sensor allow a dynamic amount of sag relative to each other.
